(19) United States
(12) Patent Application Publication
(10) Pub. No.: US 2016/0260285 A1
(43) Pub. Date: Sep. 8, 2016

(54) SYSTEM AND DEVICE HAVING FANTASY-SPORTS MECHANISM

(71) Applicant: Scientific Games International, Inc., Alpharetta, GA (US)

(72) Inventor: Thomas Kerr George, Alpharetta, GA (US)

(21) Appl. No.: 15/050,004

(22) Filed: Feb. 22, 2016

Related U.S. Application Data
(60) Provisional application No. 62/127,126, filed on Mar. 2, 2015.

(51) Int. Cl. G07F 17/32

(52) U.S. Cl. CPC G07F 17/3227; G07F 17/3244; G07F 17/3241; G07F 17/3295; G07F 17/3204; G07F 17/322

(57) ABSTRACT

Operating a fantasy sports game that leverages player skill to provide limited opportunities to select game elements and incorporates real-life performance of human athletes to determine a computer-guided outcome. An entry fee is received from an entrant to play the game. An electronic display device presents a roster of real-life athletes of a real-life sport automatically selected from a pool of selectable real-life athletes. Entrant input is received that identifies, at the entrant's option, none, all, or at least one but less than all of the athletes in the roster to be replaced. The identified athletes, if any, are replaced in the roster with other real-life athletes automatically selected from the same pool. A total score is determined based on respective individual scores of the athletes in the roster from their respective real-life performance in the real-life sport. An award is awarded when the total score satisfies a predetermined criterion.

### CLAIM OF PRIORITY AND CROSS-REFERENCE TO RELATED APPLICATION

This application claims the benefit of priority to U.S. Provisional Patent Application No. 62/127,126, which was filed on Mar. 2, 2015, and is incorporated herein by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming systems, apparatus, and methods and, more particularly, to a fantasy sports game having a computer-generated draw mechanic.

### BACKGROUND OF THE INVENTION

The gaming industry depends upon player participation. Some wagering games create a feeling of luck using a random element generator to generate one or more random elements such as random numbers. The gaming apparatus determines a game outcome based, at least in part, on the one or more random elements. Other wagering games can create the illusion or appearance that player skill can influence the outcome, even though it does not. Wagering games generally tend to avoid relying on actual skill to influence the outcome to ensure regulatory compliance. Thus, wagering games have sought heretofore to create the illusion of skill, but cannot actually allow player skill to influence the outcome. There is a need for a sports play feature with a computer-generated draw mechanic that can leverage a player's skill in making input selections prior to the outcome's being generated.

### SUMMARY OF THE INVENTION

According to one aspect of the present disclosure, a computer-implemented method of operating a gaming system that leverages player skill to provide limited opportunities to select game elements and incorporates real-life performance of human athletes to determine a computer-guided outcome, is disclosed. The method includes the steps of: receiving, by at least one of one or more controllers, an entry fee from an entrant to play a fantasy sports game; causing, by at least one of the one or more controllers, an electronic display device to present a roster of real-life athletes of a real-life sport from a pool of selectable real-life athletes; receiving, via an electronic input device, entrant input identifying, at the entrant's option, none, all, or at least one but less than all of the athletes in the roster to be replaced; replacing, by at least one of the one or more controllers, the identified athletes in the roster with other real-life athletes randomly selected from the pool; repeating the receiving and replacing steps none or more times; after the repeating step, determining, by at least one of the one or more controllers, a total score associated with the roster, each athlete in the roster having a respective individual score calculated from a real-life performance of the athlete in the real-life sport, the total score being based on a combination of the individual scores of the respective athletes in the roster; and awarding, by at least one of the one or more controllers, an award in response to the total score meeting a predetermined criterion.

The real-life athletes in the roster can play a plurality of different positions in the real-life sport such that each of the positions is filled by a respective one of the real-life athletes in the roster. Each selectable athlete can bear indicia including an image of the real-life athlete and a rank indicating a projected real-life performance of the real-life athlete. The real-life athletes presented in the roster can be selected randomly using a random number generator by at least one of the one or more controllers from the pool of selectable real-life athletes. Each of at least some of the athletes in the pool can have an associated weighting. The athletes of the roster can be randomly selected from the pool based on at least the associated weighting of respective ones of the athletes of the roster.

The method can further include: associating the roster with the entrant; and after the repeating step, permitting the entrant to access the roster from a client device and causing the client device to present a running score associated with the roster and running scores associated with other entrants' rosters of real-life athletes. The associating can include determining, by at least one of the one or more controllers, an entry code representing the roster. The permitting can include receiving the entry code via the client device.

According to another aspect of the present disclosure, a device is disclosed for hosting a computer-implemented game that leverages player skill to provide limited opportunities to select game elements of a fantasy sports game and incorporates real-life performance of human athletes to determine a computer-guided outcome. The game is played on a remote device having a housing and an electronic display device and an electronic input device coupled to the housing. The electronic input device is configured to receive a physical input from an entrant of the fantasy sports game to initiate the fantasy sports game and transform the input into an electronic data signal. The device includes: one or more communication interfaces configured to receive the electronic data signal from the remote device; and game-logic circuitry. The game-logic circuitry is configured to: receive, via the at least one of the one or more communication interfaces, an entry fee corresponding to the electronic data signal to initiate play of the fantasy sports game; select a roster of real-life athletes of a real-life sport from a pool of selectable real-life athletes; communicate the roster to the remote device to cause the electronic display device of the remote device to present the roster; receive, via at least one of the one or more communication interfaces, entrant input identifying, at the entrant's option, none, all, or at least one but less than all of the athletes in the roster to be replaced; replace in the roster the identified athletes in the roster with other real-life athletes randomly selected from the pool;

repeat the receiving and replacing steps none or more times; after the repeating step, determine a total score associated with the roster, each athlete in the roster having a respective individual score calculated from a real-life performance of the athlete in the real-life sport, the total score being based on a combination of the individual scores of the respective athletes in the roster; and award an award in response to the total score meeting a predetermined criterion.

At least one of the one or more communication interfaces can couple the device to a computer network. The game-logic circuitry can include an electronic controller. The real-life athletes in the roster can play a plurality of different positions in the real-life sport such that each of the positions is filled by a respective one of the real-life athletes in the roster. Each selectable athlete can bear indicia including an image of the real-life athlete and a rank indicating a projected real-life performance of the real-life athlete.

The game-logic circuitry can be further configured to: associate the roster with the entrant by receiving an entry code representing the roster; and after the repeating step, permit the entrant to access the roster using the entry code, thereby presenting a running score associated with the roster and running scores associated with other entrants' rosters of real-life athletes.

Each of at least some of the athletes in the pool can have an associated weighting. The athletes of the roster can be selected randomly from the pool based on at least the associated weighting of respective ones of the athletes of the roster.

According to another aspect of the present disclosure, a gaming system operating a computer-implemented game that leverages player skill to provide limited opportunities to select game elements of a fantasy sports game and incorporates real-life performance of human athletes to determine a computer-guided outcome, is disclosed. The game is portrayed on an electronic device having a housing, an electronic display device, and an electronic input device. The electronic display device and the electronic input device are coupled to the housing. The electronic input device is configured to receive from an entrant of the fantasy sports game a physical input related to the fantasy sports game and to transform the input into a corresponding electronic data signal. The gaming system includes: one or more communication interfaces configured to receive the electronic data signal from the electronic device; and game-logic circuitry. The game-logic circuitry is configured to: receive, via at least one of the one or more communication interfaces, an entry fee corresponding to the electronic data signal to initiate play of the fantasy sports game; select a roster of real-life athletes of a real-life sport from a pool of selectable real-life athletes; communicate, via at least one of the one or more communication interfaces, the roster to the electronic device to cause the electronic display device of the electronic device to present the roster of real-life athletes; receive, via at least one of the one or more communication interfaces, entrant input identifying, at the entrant's option, none, all, or at least one but less than all of the athletes in the roster to be replaced; replace in the roster the identified athletes in the roster with other real-life athletes randomly selected from the pool;

repeat the receiving and replacing steps none or more times; after the repeating step, determine a total score associated with the roster, each athlete in the roster having a respective individual score calculated from a real-life performance of the athlete in the real-life sport, the total score being based on a combination of the individual scores of the respective athletes in the roster; and award an award in response to the total score meeting a predetermined criterion.

The game-logic circuitry can include an electronic controller and resides within the housing. The roster of real-life athletes can be randomly selected by the controller from the pool of selectable real-life athletes. A casino gaming machine can be coupled to the gaming system, and can be configured to receive an entry code representing the roster.

The real-life athletes in the roster can play a plurality of different positions in the real-life sport such that each of the positions is filled by a respective one of the real-life athletes in the roster. Each selectable athlete bears indicia can include an image of the real-life athlete and a rank indicating a projected real-life performance of the real-life athlete.

The game-logic circuitry can be further configured to: associate the roster with the entrant by receiving an entry code representing the roster; and after the repeating step, permit the entrant to access the roster using the entry code, thereby presenting a running score associated with the roster and running scores associated with other entrants' rosters of real-life athletes.

Each of at least some of the athletes in the pool can have an associated weighting. The athletes of the roster can be randomly selected from the pool based on at least the associated weighting of respective ones of the athletes of the roster.

Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIG. 3 is an image of an exemplary basic-game screen of a wagering game displayed on a gaming machine, according to an embodiment of the present invention.

FIG. 4 is an image of an exemplary initial roster of nine randomly selected athletes presented on an electronic display device.

FIG. 5 is an image of the initial roster shown in FIG. 4 with selections exercised at the entrant's option to save four of the nine athletes in the roster and to exchange the other five athletes.

FIG. 6 is an image reflecting new randomly selected athletes replacing those athletes selected to be replaced in FIG. 5 in an updated roster.

FIG. 7 is an image showing a further exercise by the entrant of an option to exchange two of the nine athletes and save the remaining seven athletes in the updated roster.

FIG. 8 is an image of a final roster of nine players, including two new athletes that replace the two athletes identified for exchange in FIG. 7.

FIG. 9 is a flowchart for an example data processing method that corresponds to instructions executed by a controller in accord with at least some aspects of this disclosure.

While the aspects of this disclosure are susceptible to various modifications and alternative forms, specific implementations and configurations have been shown by way of example in the drawings and will be described in detail herein. It should be understood, however, that the disclosed features are not intended to be limited to the particular forms disclosed. Rather, this disclosure covers all modifications, equivalents, and alternatives falling within the spirit and scope of the invention or inventions as defined by the appended claims.

### DETAILED DESCRIPTION

While this disclosure is susceptible of configuration and implementation in many different forms, there is shown in the drawings and will herein be described in detail examples of the inventions with the understanding that the present disclosure is to be considered as an exemplification of the principles of the inventions and is not intended to limit the broad aspect of the inventions to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

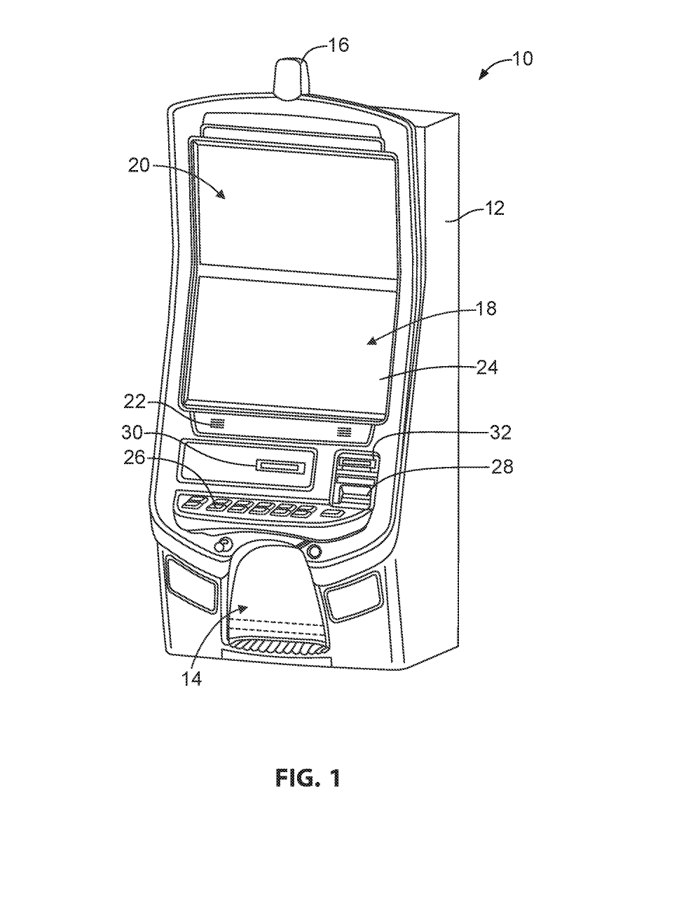

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in US Pat. Nos. 6517433, 8057303, and 8226459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary display 18, a secondary display 20, and one or more audio speakers 22. The primary display 18 or the secondary display 20 may be a mechanical-reel display device, a video display device, or a combination thereof in which a transmissive video display is disposed in front of the mechanical-reel display to portray a video image superimposed upon the mechanical-reel display. The displays variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen(s) 24 mounted over the primary or secondary displays, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

The gaming machine 10 includes one or more value input/payment devices and value output/payout devices. The value input devices are used to deposit cash or credits onto the gaming machine 10. The cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. The value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

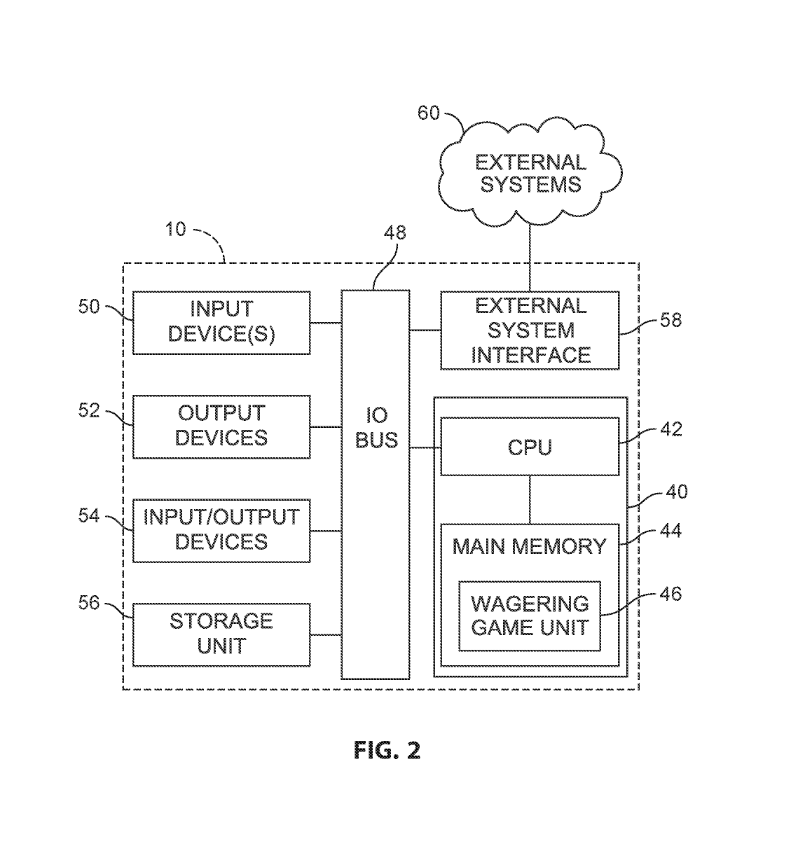

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video black jack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

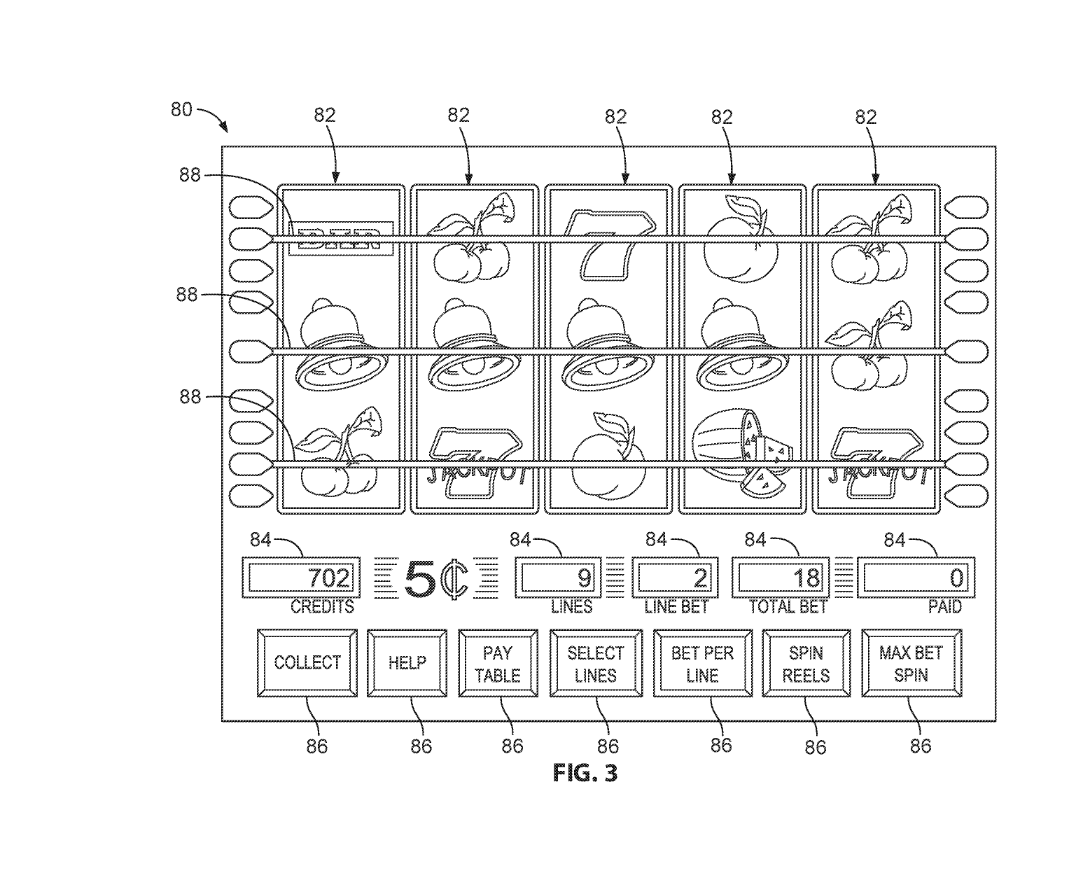

Referring now to FIG. 3, there is illustrated an image of a basic-game screen 80 adapted to be displayed on the primary display 18 or the secondary display 20. The basic-game screen 80 portrays a plurality of simulated symbol-bearing reels 82. Alternatively or additionally, the basic-game screen 80 portrays a plurality of mechanical reels or other video or mechanical presentation consistent with the game format and theme. The basic-game screen 80 also advantageously displays one or more game-session credit meters 84 and various touch screen buttons 86 adapted to be actuated by a player. A player can operate or interact with the wagering game using these touch screen buttons or other input devices such as the buttons 26 shown in FIG. 1. The game-logic circuitry 40 operates to execute a wagering-game program causing the primary display 18 or the secondary display 20 to display the wagering game.

In response to receiving an input indicative of a wager, the reels 82 are rotated and stopped to place symbols on the reels in visual association with paylines such as paylines 88. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 18 or secondary display 20) through the display of information such as, but not limited to, text, graphics, static images, moving images, etc., or any combination thereof. In accord with the method of conducting the wagering game, the game-logic circuitry 40 transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary display 18, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in other gaming jurisdictions. As can be seen from the description herein, the gaming machine 10 may be implemented with hardware and software architectures, circuitry, and other special features that differentiate it from general-purpose computers (e.g., desktop PCs, laptops, and tablets).

Fantasy sports, such as fantasy football, attract casual and sophisticated fans alike and everyone in between. Sophisticated or expert fantasy sport players believe that through their skill, cleverness, hard work, and insight they can “win” at fantasy sports. They believe that they have an edge or an acumen cultivated through knowledge, hard work, and insight that improves their odds of edging out other players. Less sophisticated fantasy sport fans or even casual ones can sometimes become intimidated in the face of participation by sophisticated players and the time investment to monitor and adjust strategies based on performances by the real-life sports athletes. These types of fans may feel at a disadvantage, leading them to place relatively small entry fees or worse not to participate at all. A significant source of reluctance materializes during the selection of the fantasy sport roster. The roster permutations are staggering, and to make rational and informed selections, it is advantageous for the fantasy sport player to be armed with a wealth of historical performance information and intimate knowledge of the teams and their athletes, team performances relative to all other teams and all permutations thereof, spreads and all manner of statistics, and so on.

There is a randomness stemming from the vagaries of real-life performances by real-life sports athletes and the attendant risks associated with life (injuries or unexpected illnesses, and the like), where the sport games can be affected by innumerable and incalculable factors. Aspects of the present disclosure exploit real-life randomness coupled with a machine-generated random draw mechanic that can be partially influenced by a fantasy sport player, which appeals to fantasy sports players of all levels, from novice to expert and every level in between. Novice players can rely on the draw mechanic's luck factor to populate a roster, and changes to the roster can be made simply by exchanging real-life players having low star ratings. Expert players can utilize their perceived edge by making exchanges based on their skill, insight, etc. While the luck factor can be relied upon by novice players of the game, expert players can use their skills to increase their chances of a favorable return on their investment. Technical aspects of the present disclosure are integral to realizing these objectives, which involve a careful balancing of randomness, controlling game element selection choice by an entrant at the entrant's option, and player skill, to produce probabilistically an award whose amount is much higher than the amount the player paid to participate in the game. In some aspects, the games disclosed herein are improved by suppressing game element volatility and incorporating real-life performance of humans, which adds additional uncertainty to the game. Alternately or additionally, player skill in making game element selections via a computer-guided draw mechanic can be utilized to improve the player's chances of winning.

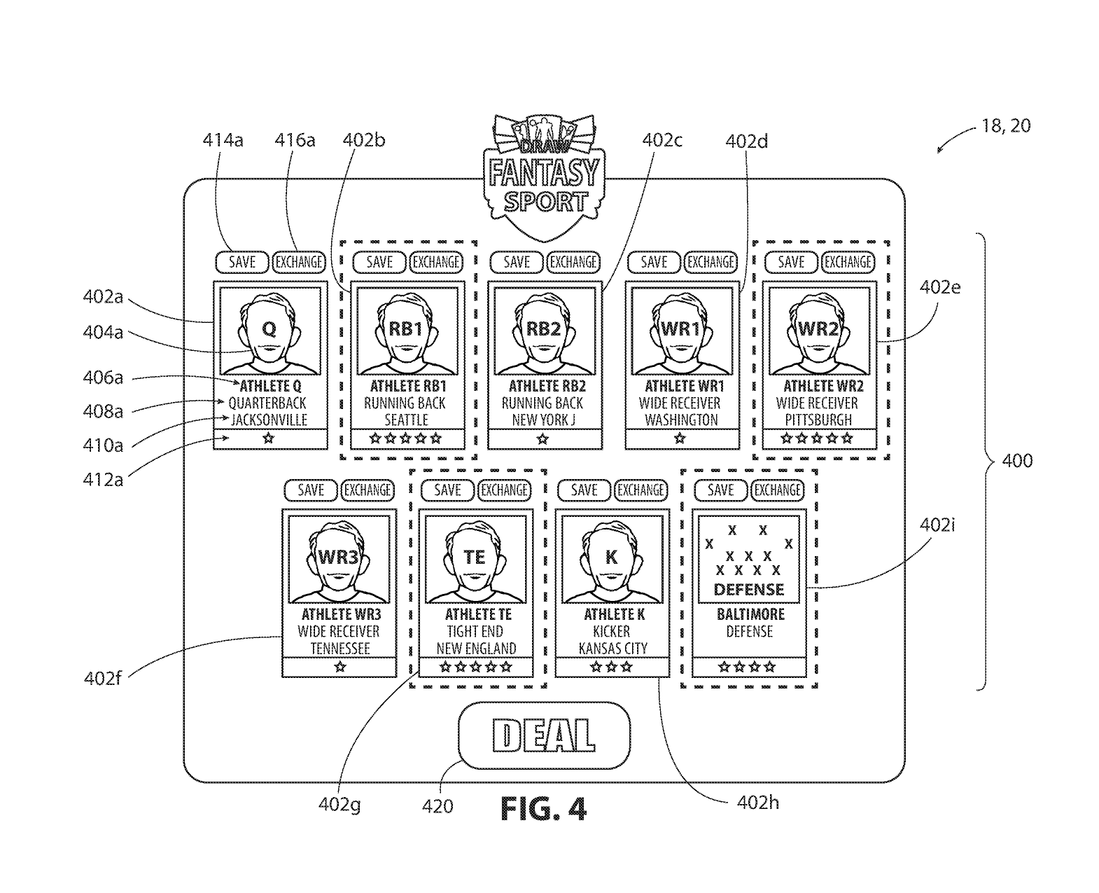

FIG. 4 illustrates an example computer-generated or computer-guided draw mechanic for a fantasy sport game. The fantasy sport game can be in the form of, for example, a regulated casino wagering game or a regulated lottery game or a consumer promotion application. A computer-guided draw mechanic describes a sequence of steps or acts that cause a set of game elements, such as real-life sports athletes, to be drawn from a pool of selectable athletes, where the athletes can be drawn randomly, or partially randomly and partially using the player's skill, and/or partially weighted so that certain types or ranks of athletes have a better chance of populating the initial pool. The weighting applied can be a function of the athlete's star ranking, for example. Athletes, as used herein, are real-life human athletes, who play real-life positions in a real-life sport. Athletes are differentiated from “players” herein, as players refer to a participant of the fantasy sport game. A participant can also be referred to as an “entrant” who pays an entry fee or provides some other legal form of consideration to participate in the fantasy sports game. The term “entry fee” as used herein includes any legal form of consideration, such as an amount of money or a promotional credit. The draw mechanic can result in a roster, as that term is understood in sports, composed of real-life athletes. For convenience and ease of discussion, the descriptor “real-life” may be dropped when referring to athletes. A real-life athlete is distinct from a fictional athlete or an avatar. The present disclosure is not limited to any particular fantasy sport, and contemplates any sport played by real-life athletes, including professional athletes. A fantasy sport is a statistical game in which fantasy sport players compete against each other by managing groups of real-life athletes or position units (such as defense) selected from a real-life sport team. Thus, a fantasy sport results in a fantasy sport team, because it is composed of athletes from many different teams who do not play in real life on the same team. The “fantasy” aspect of this game derives from the freedom to combine athletes from different teams to create a singular “fantasy” or “dream” team that will best all other fantasy teams submitted by other entrants in a fantasy sport league.

As will be described below, the draw mechanic begins with a computer-generated selection of an initial roster of athletes, and permits one or more rounds of exchanging none, some, or all of the athletes in none, some, or all sport positions in the roster. As mentioned above, the athletes can be selected randomly by a random element generator using a computer. Alternately or additionally, some or all of the athletes can be assigned one or more weightings and then randomly selected as a function of their respective weightings. These weightings can be based on actual real-life events that occur impacting the athlete so that the weighting can vary over time, on the athlete's star ranking, on a fixed basis, or on promotional considerations for a particular jurisdiction, for example. The fantasy sport player can have complete discretion in which one or more athletes to exchange using his or her skill, but once an exchange decision has been made by the player, the replacement athlete is determined by the computer so that all of the athletes who populate the roster have been selected by the computer, but the player has had the option to select which position unit(s) for which to exchange athletes. A position or position unit as that term is used here refers to the position a real-life athlete plays in a real-life sport, such as in the case of American football, for example, can include quarterback, running back, tight end, defense, and so forth.

Returning to FIG. 4, an example roster of real-life athletes 400 is displayed on a video display, such as the primary or secondary display 18, 20 of the gaming machine 10 or a video display of a portable electronic device such as a smartphone, and controlled or operated by one or more central processing units, such as the CPU 42, or by an external system 60. For convenience, the reference number 10 shall refer herein to the gaming machine 10 described above in connection with FIGS. 1-3, or to any computing device such as a portable electronic device or a computer or computer system. Inputs relative to the roster 400 shown on the display 18, 20 can be made using a touch screen, such as the touch screen 24, or any other human-machine interface device, such as a keyboard, a button, a mouse, a camera, a gesture sensing system, and the like. The reference numbers 18, 20 refer to herein to any video display on any device, such as on the gaming machine 10 or on a computing device. The reference number 24 refers to herein to any touch screen on any device, such as on the gaming machine 10 or on a computing device. An entrant inputs an entry fee, or other consideration (in the legal sense) is received from the entrant, to play a fantasy sports game, and this entry fee or consideration is received at the CPU 42 or the external system 60. Once the entry fee or consideration has been received, a random element generator is used to randomly select a roster of real-life athletes of a real-life sport from a pool of selectable real-life athletes. The pool of selectable real-life athletes can be stored as database records in a database, such as a database that is part of the external system 60, for example. The roster 400, in a first example, can be a complete or a full roster, as defined by the particular real-life sport being displayed on the display 18, 20. In this first example, the roster 400 has a fixed number of positions to be occupied by computer-selected real-life athletes, and the number of positions cannot be changed as those fixed number of positions of the roster 400 are computer-populated with real-life athletes. In this first example, the roster 400 has nine positions, each to be occupied by a single real-life athlete or a position unit played by one or more real-life athletes. In FIG. 4, the roster 400 is for a fantasy football game and contains a quarterback, two running backs, three wide receivers, a tight end, a kicker, and a defense. Of course, in other fantasy football games, different combinations of positions can be used, and in other fantasy sport games, different positions can be used. As will be seen, all nine positions are always populated with computer-selected players during the computer-guided draw mechanic.

The roster 400 shows nine positions occupied by one player or one position unit in the form of cards 402a-402i arranged in rows on the display 18, 20. Above each card 402 are two selectable elements 414, 416, one labeled “Save” and the other labeled “Exchange.” A “card” as used herein can also refer to a selectable athlete. For ease of illustration, reference numbers are shown on the first card 402a to avoid cluttering the figure with numerous reference lines. The reference number 402 can refer to any particular card or all of the cards collectively, and will also be sometimes referred to herein as a position or position unit in the roster 400. The numbering scheme adheres to the following pattern. Each card 402 includes a suffix letter, starting with a, b, c, and so on until i. Each selectable athlete or card bears the same types of indicia, for example, a photo or image of the real-life athlete or position unit corresponding to the position in the roster 404 along with a suffix letter corresponding to its arrangement on the display 18, 20. Each card 402 also includes the corresponding athlete's name 406, along with a suffix letter to differentiate among the different athletes or position units in the roster 400. Each card 402 also includes, where applicable, the name of the position 408 played by the athlete, or as in the case of the card 402i, the name of the position unit 408 (which, in the example shown in FIG. 4, is defense), along with a suffix letter to differentiate among the different positions in the roster 400. Each card 402 includes the name of the city 410 of the team for whom the athlete shown in the photo 404 plays, followed by a suffix letter to differentiate among the different teams represented in the roster 400. Each card 402 includes a star rating or ranking 412, followed by a respective suffix letter depending on the card's arrangement in the roster 400. Thus, while not all of the reference lines and numbers are shown in FIG. 4, this labeling convention should aid the reader in understanding which player or position is being referred to in the roster 400.

The star rating or ranking 412 can be obtained or derived from ratings or rankings available from services, such as Sports Data, available at http://www.sportsdatallc.com, Stats Inc., available at http://www.stats.com, or The Sports Network, available at http://www.sportsnetworkdata.com. These exemplary services, among others, produce a rank for each real-life athlete indicating a projected real-life performance of the athlete. A higher projected performance is indicated with an increasing number of stars on each of the cards 402 displayed on the display 18, 20. As mentioned above, athletes having a higher star ranking can be assigned a higher weighting to increase their chances that the computer will select higher weighted athletes from the pool.

Furthermore, while the names 406 of the athletes are actual names, in the FIG. 4 example, they have been simplified to refer to an abbreviation corresponding to the position played by the corresponding athlete. Thus, the first athlete 404a in the roster 400 is shown as having the name Player Q, where Q stands for quarterback. This is to aid the reader in this disclosure to understand quickly which athlete in the roster is being referenced. In an actual implementation, for example, without necessarily singling out any particular athlete and merely for illustrative purposes only, the Player Q could be the quarterback Blake Bortles from Jacksonville. Likewise, the photo 404a depicts a generic human face with an abbreviation corresponding to the position the athlete plays in real life, but of course in an actual implementation a photo, rendering, or image of or associated with the real-life athlete can be shown in the athlete card 402. Each time an athlete is exchanged for a particular position in the roster 400, an apostrophe (') is added after the suffix to show the number of times that card 402 has been changed, as well as to the reference number 400 corresponding to the roster.

All nine athletes (although card 402i shows a position, namely defense, for convenience, all cards will sometimes be referred to herein as “athletes,” even though technically one, some or all of the cards can refer to a position played by a particular real-life sport team) are selected by the computer to initially populate the roster 400.

The entrant has three options available at this initial stage of the draw. The entrant can replace none, all, or at least one but less than all of the athletes in the roster 400. In other words, all three options are available to the entrant at this stage, even though the entrant exercises only one of these three options. According to the present disclosure, this option is presented to the entrant a minimum of one time until a final roster has been established, although in the examples shown in FIGS. 4-8, this option is presented twice to the entrant. Each time, the entrant can choose to replace none of the athletes, all of the athletes, or at least one but less than all of the athletes in the roster 400. All three options are available to the entrant at this time. The input from the entrant can be received via a human-machine interface, such as the touchscreen 24 or any other input device. In the example shown in FIG. 4, the entrant indicates which athletes to save or exchange by selecting one of the two selectable elements 414, 416 above each card 402. It is here that the entrant can utilize his or her skill in deciding which athletes to select for exchange to try to obtain a maximally advantageous final roster. In some respects, the skill-based selection is somewhat analogous to the game of poker, but in other respects, the skill-based selection is a complex, multi-faceted decision by the entrant that involve skills and decision-points not available during a poker game.

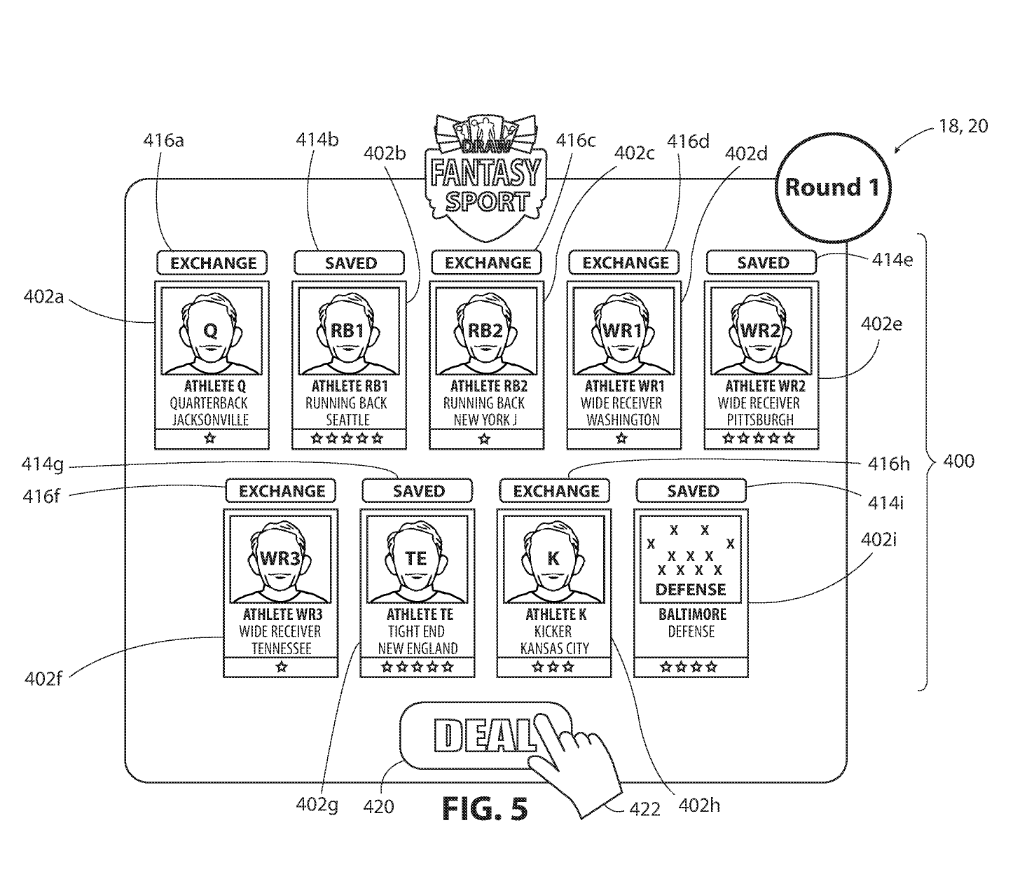

In this example, the entrant has exercised the option to save four of the athletes, corresponding to the cards 402b, 402e, 402g, and 402h, which is shown in FIG. 5. Once the entrant has completed input of the option to replace none, all, or at least one but less than all of the athletes, the entrant selects a selectable element 420 (such as in the form of a button) labeled “Deal” on the display 18, 20, to cause those athletes that the entrant selected to be exchanged to be replaced with other randomly selected athletes. Here, the selectable elements 414, 416 switch to display elements with appropriate labels reflecting the entrant's selection. Here, the display elements 416a, 416c, 416d, 416f, and 416h shown in FIG. 5 are labeled “Exchanged” to indicate that the entrant has made a choice or exercised the option, at the entrant's sole discretion, to exchange these athletes. The display elements 414b, 414e, 414g, and 414i shown in FIG. 5 are labeled ‘Saved” to indicate that the entrant has made a choice or exercised the option, at the entrant's sole discretion, to save these athletes. This is referred to as a first round of the deal mechanic, which is shown in FIG. 5 as “Round 1,” although it is not necessary to display an indicium to the entrant of how many options have been exercised. The “Round 1” label in FIG. 5 is for the reader's convenience to keep track of the sequence of the draw mechanic. In a poker game context, each round can be viewed as a replace following an initial flop (FIG. 4). Here, the entrant can use his or her perceived skill to make decisions about which athlete(s) to exchange.

Optionally, a helper animation, shown in FIG. 5 in the form of a hand 422, can be displayed on the display 18, 20 to guide the entrant on the next selection. Here, the hand 422 can be animated to show it clicking on or touching the selectable element 420 labeled “Deal” to show the entrant to select the selectable element 420 to continue completing the roster 400. The entrant submits the athletes to be exchanged and saved by selecting the selectable element 420. Here, the entrant has opted to save the athletes having the highest star ranking or rating 412. In this respect, the draw mechanic according to the present disclosure can appeal to novice fantasy sports players. It may be a safe choice to decide to save athletes having the highest star ranking. By the token, expert fantasy sports players may leverage their perceived enhanced skill or acumen to save one or more athletes where his or her star ranking is only part of the entrant's calculus. As mentioned above, the draw mechanic of the present disclosure leverages player skill to provide limited opportunities to select game elements of a fantasy sports game and incorporates real-life performance of human athletes to determine a computer-guided outcome, where the game element selections can be made using the entrant's perceived skill. Using the star rankings, the entrant will need to choose which athletes to save or exchange strategically to maximize a perceived improvement in the odds of achieving an award, but will have a limited number of opportunities to try to improve the roster 400 before the outcome of the fantasy sport team is decided by real-life events. As mentioned above, the roster 400 is initially fully and completely populated, with one athlete occupying each of (in this example) nine positions forming a full roster 400. So the fantasy sport player or entrant can exercise the option or options to save or exchange athletes with an awareness of a full roster and not an incomplete roster. Note that in these examples, the entrant is free to choose to exchange any one of the athletes in the entire roster 400 displayed on the display 18, 20. In another example, less than all of the athletes can be available for exchange. For example, one or more of the athletes displayed in the roster 400 can be “locked” so that the entrant cannot exchange them. Such non-exchangeable athletes are definitely part of the final roster 400.

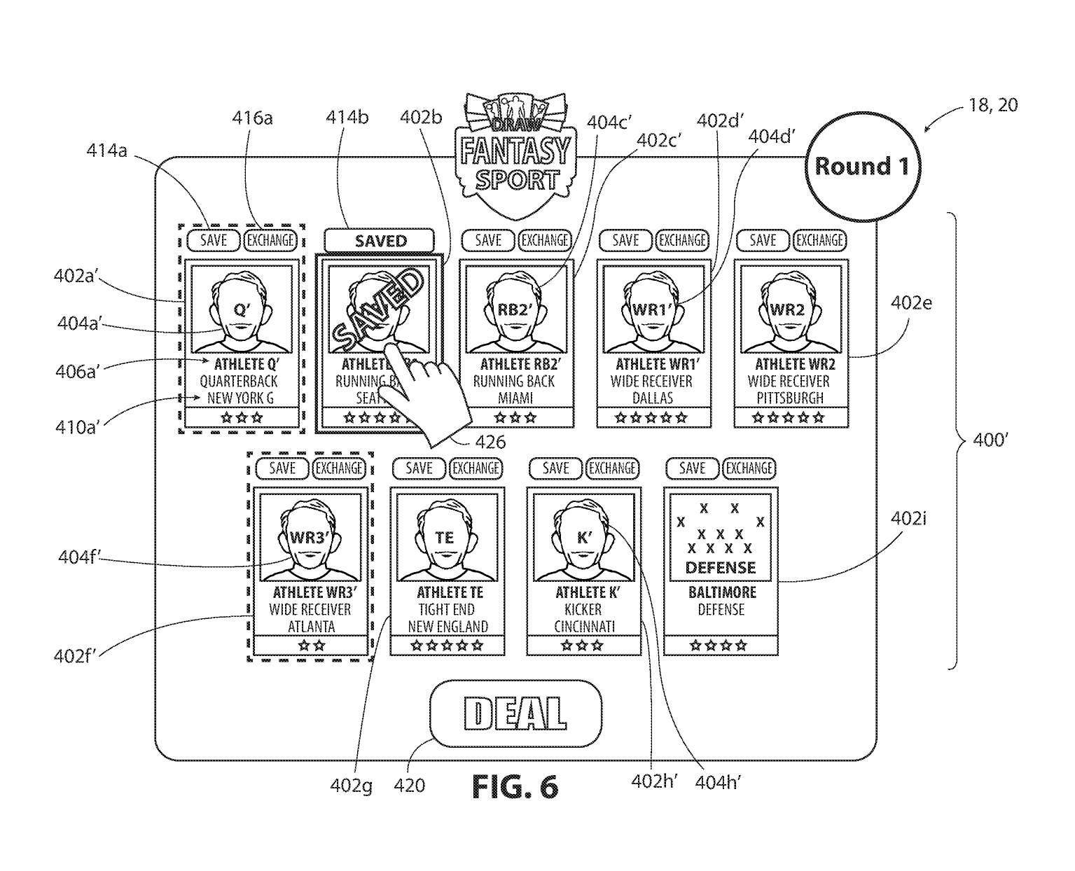

Once the entrant has selected the selectable element 420, each of the athletes selected to be exchanged in the roster 400 is replaced with a respective other real-life athlete selected by the computer from the pool of selectable real-life athletes to produce a revised or updated roster 400′ shown in FIG. 6. The replacement athlete(s) can be selected randomly by the computer, or can be selected based on a weighting factor as discussed above. Thus, once the entrant has made a choice to exchange an athlete, the replacement athlete is automatically selected by the computer from the pool of real-life athletes. In other words, the human choice factor is removed, and the computer takes over to determine which athlete will replace the athlete flagged for exchange. The only constraint is that the replacement athlete cannot be an athlete already selected to be in the roster at any previous point during the draw mechanic since the entry fee was received. Thus, the word “other” refers to any other athlete not already selected or previously selected to be included in the roster 400. The updated roster 400′ shown in FIG. 6 shows that new athletes now occupy the positions that were previously occupied by the athletes the entrant selected to be exchanged. A new quarterback is shown as Player Q′ on the card 402a′ along with a photo 402a′, the player's name 406a′, and the city of the team for whom the athlete plays 410a′. Likewise, one new running back, two new wide receivers, and a new kicker are also shown in the updated roster 400′ on respective cards 402a′, 420c′, 402d′, 402f′, and 402h′. These cards are updated to show the new stats for the respective athletes, including their name, team city, and star rating.

A helper animation in the form of a hand graphic 426 can optionally be displayed on the display 18, 20 to show the entrant how to save or exchange athletes in the roster 400′. In this example, the hand graphic 426 is shown making a save selection by selecting the selectable athlete corresponding to the card 402b. Note that the helper animation does not actually make the selection—it simply shows the entrant how to do so—the entrant makes the actual selections. Alternately, no helper animation is displayed. In this example, the entrant has exercised an option to exchange two of the selectable athletes, namely, the selectable athletes corresponding to the cards 402a′ and 402f′. Note that these athletes have already been exchanged once (in the first round), and the entrant has decided to exchange these two athletes again. Again, for the novice fantasy sport player, the star rank 412 can be a useful guide for deciding which athletes to exchange. Here, for example, the athlete shown in the card 402f′ has the lowest star ranking among all the other athletes in the roster 400′, so it is a relatively easy decision to select that athlete for exchange. However, an expert fantasy sport player may use his or her skill or acumen about fantasy sports in making a different selection. Again, as part of this second round in the draw mechanic, the entrant has the same three options to replace none, all, or at least one but less than all of the athletes in the updated roster 400′.

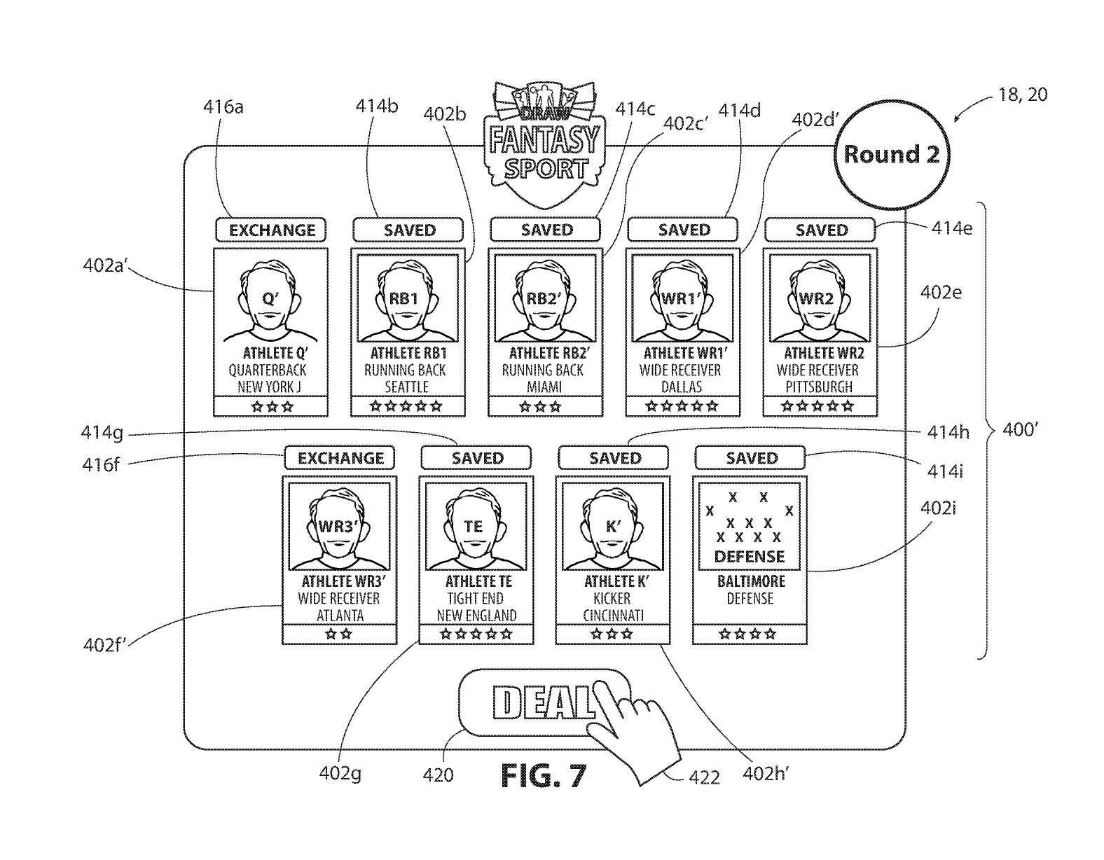

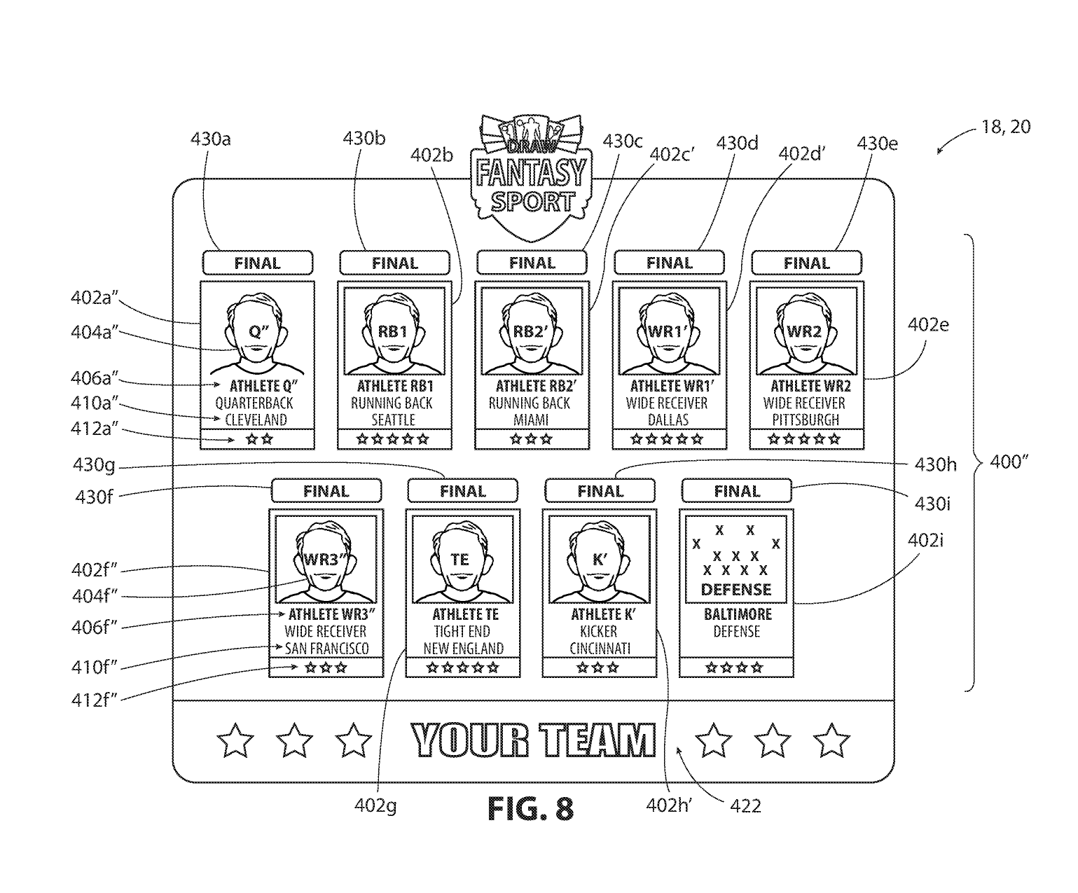

The choices made at the entrant's option are reflected in FIG. 7. Here, the entrant is shown labels 416a, 416f reflecting that the athletes corresponding to the cards 402a′ and 402f′ have been selected to be exchanged. The other athletes have been selected to be saved. A label “Round 2” is shown in FIG. 7 for ease of discussion and to differentiate from the first round, but this label need not necessarily be displayed to the entrant on the display 18, 20. An optional helper animation in the form of a hand graphic 422 can be shown guiding the entrant on submitting his or her selections by selecting the selectable element 420. The entrant selects the selectable element 420, shown in FIG. 7 in the form of a button labeled “Deal,” which causes a final roster 400″ to be displayed, such as the one shown in FIG. 8.

In FIG. 8, the final roster 400″ is shown with the final set of selectable athletes that will be used for the fantasy sport game. Here, labels 430a-430i are shown above each card 402 to indicate that these athletes represent the entrant's final selections for the final roster 400″. Note that during the draw mechanic, the roster has always contained nine athletes in this example, and the nine athletes, whether saved or exchanged, were each automatically (e.g., randomly) selected by one or more computers from the pool of selectable athletes for the fantasy sport game. The entrant can also be provided with an entry code that is associated with the final roster 400″, and the player uses this entry code to track the fantasy sport team composed of the athletes in the final roster 400″ to track that team's progress throughout the season. The entrant can use this entry code on any computing device, including the gaming machine 10, for example, anywhere to track the team's progress. An optional authentication credential can be required along with the entry code for the player to gain access to the team's performance information. For example, in a casino, the entrant can enter at least the entry code on a gaming machine 10 to track the team's performance, view a running score associated with the entrant's roster, and optionally running scores associated with other entrants' rosters of real-life athletes also participating in the fantasy sport game. For another example, the entrant can be at home on a portable tablet or anywhere on a smart phone, and enter at least the entry code to review a running score associated with the entrant's roster at any time.

The two exchanged athletes are also shown in the final roster 400″ in FIG. 8. The quarterback has been replaced by a new athlete Q″, and the identifying indicia is also shown in the card 402a″, including the team city 410a″ of the athlete Q″ and that athlete's star ranking 412a″. Likewise, the third wide receiver has been replaced by a new athlete WR3″, and the identifying indicia is also shown on the card 402f′, including the team city 410f′ of the athlete WR3″ and that athlete's star ranking 412f′. Thus, during this draw mechanic, the entrant opted (using his or her own perceived skill) to save the first running back, the second wide receiver, the tight end, and the Baltimore team defense, which has resulted in an overall better roster (according to star rankings) compared to the initial roster 400 shown in FIG. 4. The final roster 400″ has no one-star ranked athletes, and advantageously to the entrant now has four five-star ranked athletes.

Although two rounds of exchanges have been shown in FIGS. 4-8, in other examples, only one round can be permitted, or more than two rounds can be permitted. In another aspect, the entrant can purchase additional rounds by paying a higher entry fee. Thus, the number of rounds available to the entrant for making exchanges, and thereby attempting to improve the final roster, can be a function of the entry fee paid by the entrant. As mentioned above, in some examples, one or more athletes presented in the roster 400 can be locked and unavailable for exchange. In other examples, such as those illustrated, all nine athletes can be available for exchange at the entrant's option.

The pool of selectable athletes can be static and unchanging throughout the draw mechanic, such as the example depicted in FIGS. 4-8, or the pool can vary in real time or based on historical considerations. For example, if an athlete in the pool becomes injured or is otherwise expected to sit out a game, that athlete can be removed from the pool of selectable athletes. The initial “flop” of athletes, such as the example shown in FIG. 4, can be based on different weightings assigned to different athletes. The weighting associated with each athlete can change in real-time based on the relative matchups among the athletes or based on a changing star ranking associated with the athlete. Athletes having a higher star ranking are weighted heavier, so the initial flop can include a higher percentage of higher ranked athletes, for example. An athlete that may have had a low star ranking, which then suddenly increases (e.g., such as what occurred to wide receiver Odell Beckham, Jr.), can be associated in real time with a higher weight in the pool. For another example, all athletes in the pool can be weighted equally regardless of their respective star ranking. There is no duplication permitted in the roster so that no athlete can appear twice at any time in the roster 400 during the draw mechanic or in the final roster, such as the final roster 400″.

Other indicia can be optionally displayed with each card 402. For example, an indicium of a statistical probability that the athlete portrayed on the card 402 will be injured (e.g., probably, likely, or doubtful) can be indicated in the indicia. A projected stat for the athlete can be indicated, and the award can be based at least in part based on actual performance versus the original projection.

Once the final roster, such as the roster 400″ shown in FIG. 8, has been determined, a total score associated with the roster is determined. Each athlete in the roster has an individual score that is calculated from a real-life performance of the athlete in the real-life sport. The total score is based at least in part on a combination of the individual scores of the respective athletes in the roster. For example, the computer can calculate the total score based on respective on-field statistical results of each of the athletes in the final roster 400″ during a time period designated for the fantasy sports game. An award is awarded to the entrant when the total score satisfies a predetermined criterion. The awards are funded from the entry fees, and award amounts can be awarded on a pari-mutuel basis or as a guaranteed amount. Pari-mutuel-based award amounts offer protection to the fantasy sport game provider or operator, whereas guaranteed prize amounts can be more attractive to fantasy sport players. For example, award amounts awarded on a pari-mutuel basis can be attractive to lottery providers, which can guarantee a fixed rake regardless of the total amount of entry fees received, which fluctuate. Accordingly, the predetermined criterion can be based on a rake, the total score exceeding a threshold. In the highly unlikely event of a tie between two or more fantasy sport players, the award can be split or a tie-breaker can be determined by, for example, the highest total earned by the athlete occupying the quarterback position in the final roster. Awards can be based on a payout table in which players who outperform a projected outcome achieve higher awards or the entire award. Individual athlete projections for fantasy football are available from online services such as Pro Football Focus (www.profootballfocus.com), WhatlfSports (www.whatifsports.com/locker), Prediction Machine (www.predictionmachine.com), and Number Fire (www.numberfire.com). Other services provide athlete projections for other fantasy sports.

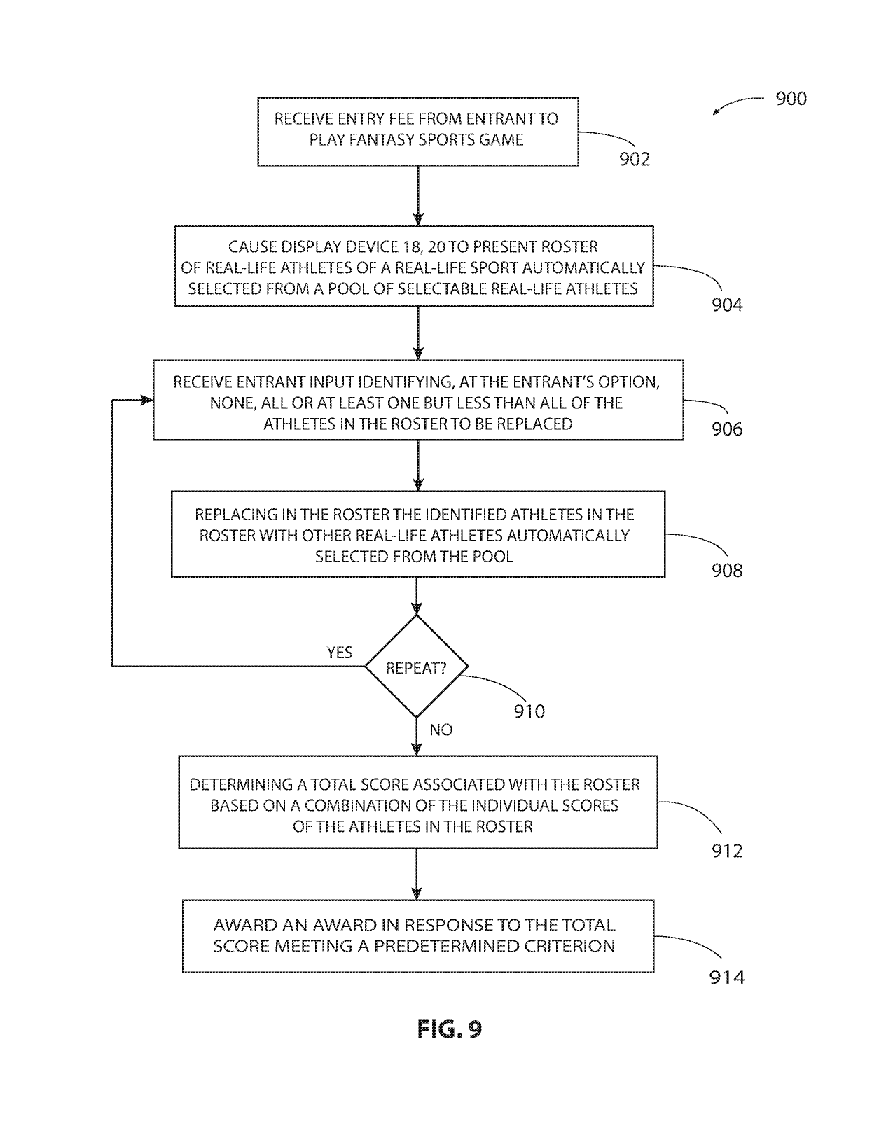

FIG. 9, described by way of example above, represents one data processing method 900 that corresponds to at least some instructions stored and executed by the game-logic circuitry 40 in FIG. 2 to perform the above described functions associated with the disclosed concepts. The data processing method 900 relates to a method of operating a gaming system that leverages player skill to provide limited opportunities to select game elements of a fantasy sports game and incorporates real-life performance of human athletes to determine a computer-guided outcome. The method 900 receives, at one of one or more controllers such as the CPU 42, an entry fee from an entrant to play a fantasy sports game (902). The method 900 causes an electronic display device, such as the display 18, 20, to present a roster of real-life athletes of a real-life sport automatically selected from a pool of selectable real-life athletes (904). The method 900 receives, via an electronic input device, such as the input device 50 or the touchscreen 24, entrant input identifying, at the entrant's option, none, all, or at least one but less than all of the athletes in the roster to be replaced (906). As mentioned above, the entrant has all three options available to choose from, but exercises just one of these three options.

The method 900 replaces in the roster, by at least one of the one or more controllers, the identified athletes in the roster with other real-life athletes automatically selected from the pool (908). The method 900 determines whether the repeat blocks 906 and 908 none or more times (910). If the method 900 determines to repeat blocks 906 and 908 again, the method 900 carries out blocks 906 and 908 again. Otherwise, after block 908, the method 900 determines, by at least one of the one or more controllers, a total score associated with the roster (912). Each athlete in the roster has a respective individual score calculated from a real-life performance of the athlete in the real-life sport. The total score is based on a combination of the individual scores of the respective athletes in the roster. Finally, the method 900 awards, by at least one of the one or more controllers, an award in response to the total score meeting a predetermined criterion (914).

Aspects of the present disclosure bring together a machine, human skill, and randomness of real-life events that occur in the physical world to realize a draw mechanic where the player's skill can be used to improve the game outcome. The machine (e.g., a computing device) is initially involved in determining the athletes to populate a full roster without human player involvement or influence. The human player then uses his or her skill to exchange none, at least one, or less than all athletes in one or more rounds to improve the overall roster. Control by the human player is relinquished and passed back to the machine that determines, again without human player involvement or influence, which athletes will replace those identified to be exchanged. This can be repeated, none, one, or more times until a final roster has been completed. Once the final roster has been completed, the on-field actions of the real-life human athletes in the final roster influence the outcome of the game. The actions of the athletes are beyond the control of the player and the machine, so the outcome is at the mercy of at least the real-life performances of the athletes. What emerges is a game in which the player has the dominion over eliminating athletes that the player deems to be detrimental or undesirable using the player's skill, the machine has dominion over selecting the athletes that populate the roster, and the real-life athletes in the final roster determine the real-life actions in the physical world that are used to determine the outcome. The player cannot influence the selection of a replacement athlete once the player has made his or her exchange selections. Other than optionally displaying star rankings of the athletes, the computer is not otherwise involved whatsoever in the exchange selection. The game outcome is a function of at least the quasi-random or random selections made by the computer to populate a roster, the skill-based selections made by the player to exchange athletes on the roster to improve it, and the real-life actions of real-life athletes in the physical world who occupy final roster.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A computer-implemented method of operating a gaming system that leverages player skill to provide limited opportunities to select game elements and incorporates real-life performance of human athletes to determine a computer-guided outcome, the method comprising the steps of:
receiving, by at least one of one or more controllers, an entry fee from an entrant to play a fantasy sports game;
causing, by at least one of the one or more controllers, an electronic display device to present a roster of real-life athletes of a real-life sport from a pool of selectable real-life athletes;
receiving, via an electronic input device, entrant input identifying, at the entrant's option, none, all, or at least one but less than all of the athletes in the roster to be replaced;
replacing, by at least one of the one or more controllers, the identified athletes in the roster with other real-life athletes randomly selected from the pool;
repeating the receiving and replacing steps none or more times;
after the repeating step, determining, by at least one of the one or more controllers, a total score associated with the roster, each athlete in the roster having a respective individual score calculated from a real-life performance of the athlete in the real-life sport, the total score being based on a combination of the individual scores of the respective athletes in the roster; and
awarding, by at least one of the one or more controllers, an award in response to the total score meeting a predetermined criterion.

2. The method of claim 1, wherein the real-life athletes in the roster play a plurality of different positions in the real-life sport such that each of the positions is filled by a respective one of the real-life athletes in the roster.

3. The method of claim 1, wherein each selectable athlete bears indicia including an image of the real-life athlete and a rank indicating a projected real-life performance of the real-life athlete.

4. The method of claim 1, further including:
associating the roster with the entrant; and
after the repeating step, permitting the entrant to access the roster from a client device and causing the client device to present a running score associated with the roster and running scores associated with other entrants' rosters of real-life athletes.

5. The method of claim 4, wherein the associating includes determining, by at least one of the one or more controllers, an entry code representing the roster, and wherein the permitting includes receiving the entry code via the client device.

6. The method of claim 1, wherein the real-life athletes presented in the roster are selected randomly using a random number generator by at least one of the one or more controllers from the pool of selectable real-life athletes.

7. The method of claim 1, wherein each of at least some of the athletes in the pool has an associated weighting, and wherein the athletes of the roster are randomly selected from the pool based on at least the associated weighting of respective ones of the athletes of the roster.

8. A device for hosting a computer-implemented game that leverages player skill to provide limited opportunities to select game elements of a fantasy sports game and incorporates real-life performance of human athletes to determine a computer-guided outcome, the game being played on a remote device having a housing and an electronic display device and an electronic input device coupled to the housing, the electronic input device being configured to receive a physical input from an entrant of the fantasy sports game to initiate the fantasy sports game and transform the input into an electronic data signal, the device comprising:
one or more communication interfaces configured to receive the electronic data signal from the remote device; and
game-logic circuitry configured to:
receive, via the at least one of the one or more communication interfaces, an entry fee corresponding to the electronic data signal to initiate play of the fantasy sports game;
select a roster of real-life athletes of a real-life sport from a pool of selectable real-life athletes;
communicate the roster to the remote device to cause the electronic display device of the remote device to present the roster;
receive, via at least one of the one or more communication interfaces, entrant input identifying, at the entrant's option, none, all, or at least one but less than all of the athletes in the roster to be replaced;
replace in the roster the identified athletes in the roster with other real-life athletes randomly selected from the pool;
repeat the receiving and replacing steps none or more times;
after the repeating step, determine a total score associated with the roster, each athlete in the roster having a respective individual score calculated from a real-life performance of the athlete in the real-life sport, the total score being based on a combination of the individual scores of the respective athletes in the roster; and
award an award in response to the total score meeting a predetermined criterion.

9. The device of claim 8, wherein at least one of the one or more communication interfaces couple the device to a computer network, and wherein the game-logic circuitry includes an electronic controller.

10. The device of claim 8, wherein the real-life athletes in the roster play a plurality of different positions in the real-life sport such that each of the positions is filled by a respective one of the real-life athletes in the roster.

11. The device of claim 8, wherein each selectable athlete bears indicia including an image of the real-life athlete and a rank indicating a projected real-life performance of the real-life athlete.

12. The device of claim 8, wherein the game-logic circuitry is further configured to:
associate the roster with the entrant by receiving an entry code representing the roster; and
after the repeating step, permit the entrant to access the roster using the entry code, thereby presenting a running score associated with the roster and running scores associated with other entrants' rosters of real-life athletes.

13. The device of claim 8, wherein each of at least some of the athletes in the pool has an associated weighting, and wherein the athletes of the roster are selected randomly from the pool based on at least the associated weighting of respective ones of the athletes of the roster.

14. A gaming system operating a computer-implemented game that leverages player skill to provide limited opportunities to select game elements of a fantasy sports game and incorporates real-life performance of human athletes to determine a computer-guided outcome, the game being portrayed on an electronic device having a housing, an electronic display device, and an electronic input device, the electronic display device and the electronic input device being coupled to the housing, the electronic input device configured to receive from an entrant of the fantasy sports game a physical input related to the fantasy sports game and to transform the input into a corresponding electronic data signal, the gaming system comprising:
one or more communication interfaces configured to receive the electronic data signal from the electronic device; and
game-logic circuitry configured to:
receive, via at least one of the one or more communication interfaces, an entry fee corresponding to the electronic data signal to initiate play of the fantasy sports game;
select a roster of real-life athletes of a real-life sport from a pool of selectable real-life athletes;
communicate, via at least one of the one or more communication interfaces, the roster to the electronic device to cause the electronic display device of the electronic device to present the roster of real-life athletes;
receive, via at least one of the one or more communication interfaces, entrant input identifying, at the entrant's option, none, all, or at least one but less than all of the athletes in the roster to be replaced;
replace in the roster the identified athletes in the roster with other real-life athletes randomly selected from the pool;
repeat the receiving and replacing steps none or more times;
after the repeating step, determine a total score associated with the roster, each athlete in the roster having a respective individual score calculated from a real-life performance of the athlete in the real-life sport, the total score being based on a combination of the individual scores of the respective athletes in the roster; and
award an award in response to the total score meeting a predetermined criterion.

15. The gaming system of claim 14, wherein the game-logic circuitry includes an electronic controller and resides within the housing, and wherein the roster of real-life athletes are randomly selected by the controller from the pool of selectable real-life athletes.

16. The gaming system of claim 14, wherein a casino gaming machine is coupled to the gaming system, and is configured to receive an entry code representing the roster.

17. The gaming system of claim 14, wherein the real-life athletes in the roster play a plurality of different positions in the real-life sport such that each of the positions is filled by a respective one of the real-life athletes in the roster.

18. The gaming system of claim 14, wherein each selectable athlete bears indicia including an image of the real-life athlete and a rank indicating a projected real-life performance of the real-life athlete.

19. The gaming system of claim 14, wherein the game-logic circuitry is further configured to:
associate the roster with the entrant by receiving an entry code representing the roster; and
after the repeating step, permit the entrant to access the roster using the entry code, thereby presenting a running score associated with the roster and running scores associated with other entrants' rosters of real-life athletes.

20. The gaming system of claim 14, wherein each of at least some of the athletes in the pool has an associated weighting, and wherein the athletes of the roster are randomly selected from the pool based on at least the associated weighting of respective ones of the athletes of the roster.
